(19) United States
(12) Patent Application Publication
(10) Pub. No.: US 2006/0126744 A1
(43) Pub. Date: Jun. 15, 2006

(54) Two pass architecture for H.264 CABAC decoding process

(76) Inventors: Liang Peng, San Jose, CA (US); Ankur Shah, Sunnyvale, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/181,204

(22) Filed: Jul. 13, 2005

Related U.S. Application Data
(60) Provisional application No. 60/635,114, filed on Dec. 10, 2004.

(51) Int. Cl. H04N 7/12; H04N 11/04; H04N 11/02; H04B 1/66

(52) U.S. Cl. 375/240.26; 375/240.25; 375/240.24

(57) ABSTRACT

An architecture capable of stream parsing of the H.264 Content Based Adaptive Binary Arithmetic Coding (CABAC) format is disclosed. The architecture employs a two pass dataflow approach to implement the functions of CABAC bit parsing and decoding processes (based on the H.264 CABAC algorithm). The architecture can be implemented, for example, as a system-on-chip (SOC) for a video/audio decoder for use high definition television broadcasting (HDTV) applications. Other such video/audio decoder applications are enabled as well.

### RELATED APPLICATIONS

This application claims the benefit of U.S. Provisional Application No. 60/635,114, filed on Dec. 10, 2004. In addition, this application is related to U.S. application Ser. No. ______, filed Jul. 13, 2005, titled “Extensible Architecture for Multi-Standard Variable Length Decoding”<attorney docket number 22682-10470>. Each of these applications is herein incorporated in its entirety by reference.

### FIELD OF THE INVENTION

The invention relates to video compression, and more particularly, to the stream parsing of the H.264 Content Based Adaptive Binary Arithmetic Coding (CABAC) format.

### BACKGROUND OF THE INVENTION

The H.264 specification, also known as the Advanced Video Coding (AVC) standard, is a high compression digital video codec standard produced by the Joint Video Team (JVT), and is identical to ISO MPEG-4 part 10. The H.264 standard is herein incorporated by reference in its entirety.

H.264 CODECs can encode video with approximately three times fewer bits than comparable MPEG-2 encoders at the same visual quality. This significant increase in coding efficiency means that more quality video data can be sent over the available channel bandwidth. In addition, many video services can now be offered in environments where they previously were not possible. H.264 CODECs would be particularly useful, for instance, in high definition television (HDTV) applications, bandwidth limited networks (e.g., streaming mobile television), personal video recorder (PVR) and storage applications for home use, and other such video delivery applications (e.g., digital terrestrial TV, cable TV, satellite TV, video over xDSL, DVD, and digital and wireless cinema).

In general, all standard video processing (e.g., MPEG-2 or H.264) encodes video as a series of pictures. For video in the interlaced format, the two fields of a frame can be encoded together as a frame picture, or encoded separately as two field pictures. Both types of encoding can be used in a single interlaced sequence. The output of the decoding process for an interlaced sequence is a series of reconstructed fields. For video in the progressive format, all encoded pictures are frame pictures. The output of the decoding process is a series of reconstructed frames.

Encoded pictures are classified into three types: I, P, and B. I-type pictures represent intra coded pictures, and are used as a prediction starting point (e.g., after error recovery or a channel change). Here, all macroblocks are coded with the prediction only from the macroblocks in the same picture. P-type pictures represent predicted pictures. Here, macroblocks can be coded with forward prediction with reference to macroblocks in previous I-type or P-type pictures, or they can be intra coded within the same pictures. B-type pictures represent bi-directionally predicted pictures. Here, macroblocks can be coded with forward prediction (with reference to the macroblocks in previous I-type and P-type pictures), or with backward prediction (with reference to the macroblocks in next I-type and P-type pictures), or with interpolated prediction (with reference to the macroblocks in previous and next I-type and P-type pictures), or intra coded within the same picture. In both P-type and B-type pictures, macroblocks may be skipped and not sent at all. In such cases, the decoder uses the anchor reference pictures for prediction with no error.

The advanced coding techniques of the H.264 specification operate within a similar scheme as used by previous MPEG standards. The higher coding efficiency and video quality are enabled by a number of features, including improved motion estimation and inter prediction, spatial intra prediction and transform, and context-adaptive binary arithmetic coding (CABAC) and context-adaptive variable length coding (CAVLC) algorithms.

As is known, motion estimation is used to support inter picture prediction for eliminating temporal redundancies. Spatial correlation of data is used to provide intra picture prediction (prior to the transform). Residuals are constructed as the difference between predicted images and the source images. Discrete spatial transform and filtering is used to eliminate spatial redundancies in the residuals. H.264 also supports entropy coding of the transformed residual coefficients and of the supporting data such as motion vectors.

Entropy is a measure of the average information content per source output unit, and is typically expressed in bits/pixel. Entropy is maximized when all possible values of the source output unit are equal (e.g., an image of 8-bit pixels with an average information content of 8 bits/pixel). Coding the source output unit with fewer bits, on average, generally results in information loss. Note, however, that the entropy can be reduced so that the image can be coded with fewer than 8 bits/pixel on average without information loss.

The H.264 specification provides two alternative processes of entropy coding—CABAC and CAVLC. CABAC provides a highly efficient encoding scheme when it is known that certain symbols are much more likely than others. Such dominant symbols may be encoded with extremely small bit/symbol ratios. CABAC continually updates the frequency statistics of the incoming data, and adaptively adjusts the arithmetic and context model of the coding algorithm in real-time. CAVLC uses multiple variable length codeword tables to encode transform coefficients. The codeword best table is selected adaptively based on a priori statistics of already processed data. A single table is used for non-coefficient data.

The H.264 specification provides for seven profiles each targeted to particular applications, including a Baseline Profile, a Main Profile, an Extended Profile, and four High Profiles. The Baseline Profile supports progressive video, uses I and P slices, CAVLC for entropy coding, and is targeted towards real-time encoding and decoding for applications. The Main Profile supports both interlaced and progressive video with macroblock or picture level field/frame mode selection, and uses I, P, B slices, weighted prediction, as well as both CABAC and CAVLC for entropy coding. The Extended Profile supports both interlaced and progressive video, CAVLC, and uses I, P, B, SP, SI slices.

The High Profile extends functionality of the Main Profile for effective coding. The High Profile uses adaptive 8×8 or 4×4 transform, and enables perceptual quantization matrices. The High 10 Profile is an extension of the High Profile for 10-bit component resolution. The High 4:2:2 Profile supports 4:2:2 chroma format and up to 10-bit component resolution (e.g., for video production and editing). The High 4:4:4 Profile supports 4:4:4 chroma format and up to 12-bit component resolution. It also enables lossless mode of operation and direct coding of the RGB signal (e.g., for professional production and graphics).

Prior to CABAC, the arithmetic coding technique typically used in image compression is the QM-coder adopted in JPEG, JPEG2000 and JBIG standards. However, this technique uses an approximation to avoid expensive hardware multipliers, which makes the interval range updating and the probability prediction rules used in the QM-coder implementation imprecise. This has greatly limited the efficiency of the arithmetic coding. Another limitation of the QM-coder is that it does not supply a good way for the context adaptation in the bit coding process. The context based adaptive binary arithmetic coding (i.e., CABAC) proposed by the JVT committee uses an improved version of arithmetic coder, known as an M-coder. The M-coder has not only overcome the precision issue, but also simplified the operation used to update the interval range. It replaces the use of multipliers with a modulation table, which supplies sufficient information to keep track the probability state transition and the interval change. In addition to the use of M-coder, CABAC also incorporates a bit level content adaptive scheme that fine-tunes the probability model for each bit in its decoding process based on the accumulative statistics of the same bit of the same syntax element previously decoded.

However, the JVT-proposed H.264 CABAC algorithm and its various software implementations are intrinsically serialized operations. Such a software solution is very slow in performance because there is a strong dependency between consecutive bits, due to (a) the nature of the statistical modeling in the arithmetic coding, and (b) the bit level dependency in the context modeling of the H.264 CABAC decoding process. Thus, there is no known software implementation that can meet, for instance, with the real-time 30 frame per second for the performance requirement for the High Definition 1920×1080 interlace (10801) or 1280×720 progressive (720P) formats used in the broadcast standard. In addition, an H.264 CABAC bit stream has a huge bit rate fluctuation, which makes it very difficult for any implementations to build an ASIC hardware component in a SOC system to meet the real-time performance requirement for demanding applications, such as high definition video broadcasting.

What is needed, therefore, are architectures that are H.264 CABAC enabled.

### SUMMARY OF THE INVENTION

One embodiment of the present invention provides a two pass context-adaptive binary arithmetic coding (CABAC) architecture dataflow device. The device includes a first code index parser (CIP) module for parsing and decoding syntax elements from an input video elementary stream (VES), which includes information at one or more of stream sequence, picture, and slice header levels. The device also includes a CABAC module for un-wrapping dependency of arithmetic interval and context modeling between consecutive bits from the input VES, and transferring the input VES to a video transformed stream (VTS) format in which there is no bit level dependency. The device also includes an external memory for storing the resulting VTS, and a second CIP module for parsing and decoding syntax elements from the VTS. The device can be implemented, for example, as an application specific integrated circuit (ASIC) to decode H.264 CABAC streams with substantial fluctuations of bits representing each macroblock in high definition television (HDTV) applications. In one particular embodiment, a first pass, the first CIP module and the CABAC module receive and process the input VES to produce the VTS, which is written to the external memory, and in a second pass, the VTS is read back from the external memory, and syntax element parsing is performed by the second CIP module to produce syntax element values originally coded in the VES stream. In another particular embodiment, the first CIP module outputs macroblock stream and slice stream data corresponding to the input VES, and passes each stream to the CABAC module. In this case, the CABAC module includes an IPCM data determination block for analyzing the macroblock stream data, and determining if IPCM data mode is enabled. The CABAC module also includes a CABAC decoder pipeline for decoding the macroblock stream data if IPCM mode is not enabled, a bypass module for allowing the macroblock stream data to bypass the CABAC decoder pipeline if the IPCM mode is enabled, and a mixer for combining the slice stream data and the macroblock stream data at the macroblock level to form the VTS. A byte prevention pattern can be added to the VTS to make the parsing process performed by the second CIP module consistent with the first CIP module. In one such configuration, the CABAC decoder pipeline includes a slice control flow module for carrying out a slice level parsing process to determine a syntax element type from a bit stream, a binarization module for using a syntax element type to determine a context index offset, a context model for calculating a context index based on the context index offset, an M-coder module for determining a bin value within a syntax element in the VTS, based on the context index, and a bin match module for generating a bin stream that forms the VTS, based on bin values from the M-coder. The external memory can be, for example, a double data rate (DDR) RAM. The resulting VTS can be expanded in size to eliminate the dependency that existed within the original VES. In one such configuration, the expanded VTS is fed back from the external memory to the second CIP module, thereby providing a much higher performance throughput for syntax element parsing.

Another embodiment of the present invention provides a two pass context-adaptive binary arithmetic coding (CABAC) architecture dataflow device. The device includes a first pass section of the device for receiving and processing an input video elementary stream (VES) to produce a video transformed stream (VTS), a memory for storing the VTS, and a second pass section of the device for reading the VTS stream back from the memory and performing syntax element parsing to produce syntax element values coded in the VES stream. The VTS can be expanded in size to eliminate the dependency that existed between bits within the original VES. The expanded VTS can be fed back from the external memory to the second pass section, thereby providing a higher performance throughput for syntax element parsing. In one particular embodiment, the first pass section receives a bit count of a bin value within a syntax element from a bin index counter, which monitors the VTS to establish the count.

Another embodiment of the present invention provides a two pass context-adaptive binary arithmetic coding (CABAC) architecture dataflow device. The device includes a slice control flow module for carrying out a slice level parsing process to determine a syntax element type from a bit stream. The device also includes a binarization module for using a syntax element type to determine a context index offset. The device also includes a context model for calculating a context index based on the context index offset and bin index position. The device also includes an M-coder module for determining a bin value within a syntax element in a video transformed stream (VTS), based on the context index. The device also includes a bin match module for generating a bin stream that forms the VTS, based on bin values from the M-coder. The device also includes an external memory for storing the VTS, and a code index parser (CIP) module for parsing and decoding syntax elements from the stored VTS. The VTS can be expanded in size to eliminate dependency that existed between bits within the VES. The expanded VTS can be fed back from the external memory to the second CIP module, thereby providing a much higher performance throughput for syntax element parsing. In one particular case, the context model receives a bit count of the bin value within a syntax element from a bin index counter, which monitors the VTS to establish the count.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a block diagram of a two pass CABAC architecture dataflow configured in accordance with one embodiment of the present invention.

FIG. 2 is a block diagram of a CABAC decoder pipeline configured for the two pass CABAC architecture dataflow of FIG. 1, in accordance with one embodiment of the present invention.

FIG. 3 is a block diagram of the binarizer of FIG. 2, configured in accordance with one embodiment of the present invention.

FIG. 4 is a block diagram of the context model of FIG. 2, configured in accordance with one embodiment of the present invention.

FIG. 5 is a block diagram of the M-coder of FIG. 2, configured in accordance with one embodiment of the present invention.

FIG. 6 is a block diagram of the bin match module of FIG. 2, configured in accordance with one embodiment of the present invention.

### DETAILED DESCRIPTION OF THE INVENTION

An architecture capable of stream parsing of the H.264 Content Based Adaptive Binary Arithmetic Coding (CABAC) format is disclosed. The architecture employs a two pass dataflow approach to implement the functions of CABAC bit parsing and decoding processes based on the H.264 CABAC algorithm. The architecture can be implemented, for example, as part of a system-on-chip (SOC) solution for a video/audio decoder for use in high definition television broadcasting (HDTV) applications. Other such video/audio decoder applications are enabled as well.

In one such embodiment, hardware components required in the first pass of the CABAC bit parsing and processing are partitioned in two modules: a first code index parser (CIP) module and a CABAC module. The first CIP module is used for parsing and decoding the syntax elements from the input video elementary stream (VES) at the levels above the slice data level. The CABAC module is used for unwrapping the strong dependency of arithmetic and context between the consecutive bits from the input VES, transforming the input VES to a video transformed stream (VTS) format, and storing it in an external memory (e.g., DRAM). In one particular case, the VTS is slightly expanded over the original data by about 10%-25% in size. This expansion eliminates all the dependency between the bits within the input bit stream (VES). This CABAC bit parsing and processing performed by the first CIP and CABAC modules represents a first pass of the two pass dataflow approach.

The expanded VTS is then fed back from the external memory (e.g., DRAM) into a second CIP module in the second pass of the two pass dataflow approach, at a much higher performance throughput for syntax element parsing. This high throughput rate enables the speed of the syntax element parsing performance at the same performance level with subsequent stage pipeline video decoding processes. In one such embodiment, the external memory (e.g., DRAM) is used as an infinite length buffer to compensate and smooth out the variability of the output syntax element from the CABAC module, so that the entire video decoding engine has a consistent pipeline performance to meet a target performance requirement of one high definition (HD) bit stream and one standard definition (SD) bit stream.

A variety of techniques can be used to exploit instruction as well as data parallelism to improve the CABAC bit decoding performance, as will be apparent in light of this disclosure.

Two Pass Dataflow

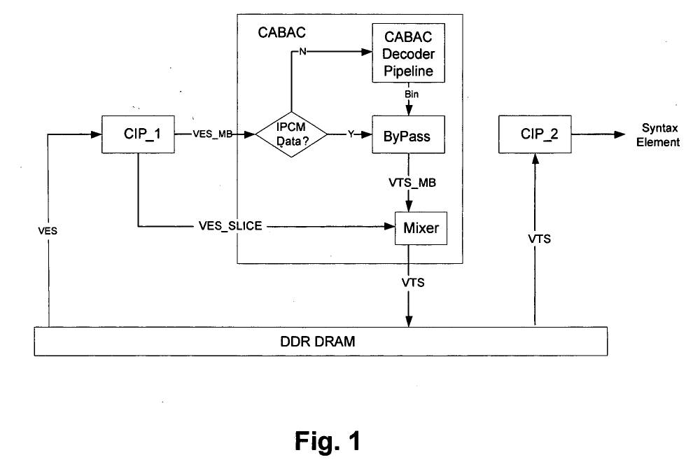

FIG. 1 is a block diagram of a CABAC two pass dataflow architecture configured in accordance with one embodiment of the present invention. The architecture can be implemented, for example, as an application specific integrated circuit (ASIC) or other purpose-built semiconductor. A two pass dataflow approach is used to resolve the huge fluctuation of the bit number representing each macroblock while keeping the high performance throughput requirement for the HDTV application. An external memory (e.g., DRAM) buffering scheme is used to balance the huge bit rate fluctuation between a CABAC module and the rest of the ASIC hardware decoder pipeline, which can be operated at a fixed rate.

As can be seen, this example two pass dataflow architecture includes a first CIP module (CIP_{—}1), a CABAC module, a second CIP module (CIP_{—}2), and an external memory, which in this example case is a double data rate (DDR) DRAM. In the first pass, the CIP_{—}1 and CABAC modules receive and process an input VES stream to produce a VTS stream, which is written to the external DRAM. In the second pass, the VTS stream is read back from the external DRAM, and syntax element parsing is performed by the CIP_{—}2 module to produce syntax element values coded in the original VES stream.

The CIP_{—}1 of the first pass is a hardware module to parse and decode the syntax elements from the original input VES, which contains the information at the stream sequence, picture or slice header levels. The CABAC decoding process, however, is done at the slice data and macroblock level of the input VES. Thus, the CIP_{—}1 module parses the input VES, and outputs the corresponding macroblock stream (VES_MB) and slice stream (VES_SLICE). The VES_MB and VES_SLICE outputs are passed to the CABAC module, to form the VTS.

The CABAC module includes an IPCM data determination block, a CABAC decoder pipeline, a bypass module, and a mixer. The VES_MB output of the CIP_{—}1 module is received at the IPCM data determination block, and the VES_SLICE output of the CIP_{—}1 module is received at the mixer. The output of the CABAC module is the VTS.

The IPCM data determination block analyzes the VES_MB input, and determines if it includes IPCM data. IPCM data is pixel data in a raw mode, where no transformation or prediction model (both intra and inter predictions) has been applied to the video data according to the H.264 specification. The IPCM mode is the preferred mode in the situation where any compression technique used within the context of the H.264 can only increase the length of the bit stream, and therefore only leads to a negative compression (i.e., data expansion). The IPCM mode is used within the context of the H.264 specification to “turn off” the inter or intra compression prediction model in order to avoid bit expansion, so that the final bit stream will include no more bits than the original raw data. In short: H.264 Encoded bits=Min (bits from model based prediction, bits from IPCM mode)<=bits in the original raw data stream.

If IPCM mode is not enabled, then the data is provided to the CABAC decoder pipeline. If IPCM mode is enabled, then the data is provided to the CABAC bypass module. The bypass module is used as a direct dataflow or feed-through without applying any change to the data. In such a situation, the VTS_MB output provided to the mixer is the same as the VES_MB input.

The mixer merges the VES_SLICE data and the VTS_MB data at the macroblock level to form a combined VTS data output of the CABAC module. Here, a byte prevention pattern can be added on the combined stream to make the parsing process by the CIP_{—}2 module of the second pass to be consistent with the CIP_{—}1 within the context of the H.264 specification.

The CIP_{—}2 module of the second pass is a hardware module configured to parse and decode the syntax elements from the VTS from the external memory, which in this case is a DDR DRAM (other types of memory devices or techniques can be used here as well for the external memory). The VTS from the external memory contains information at all levels, including the original sequence/picture/slice level header information and the bin transformed by the CABAC module at the slice data and the macroblock level. The output of the CIP_{—}2 module is the syntax element value used in the later stage of the decoding process.

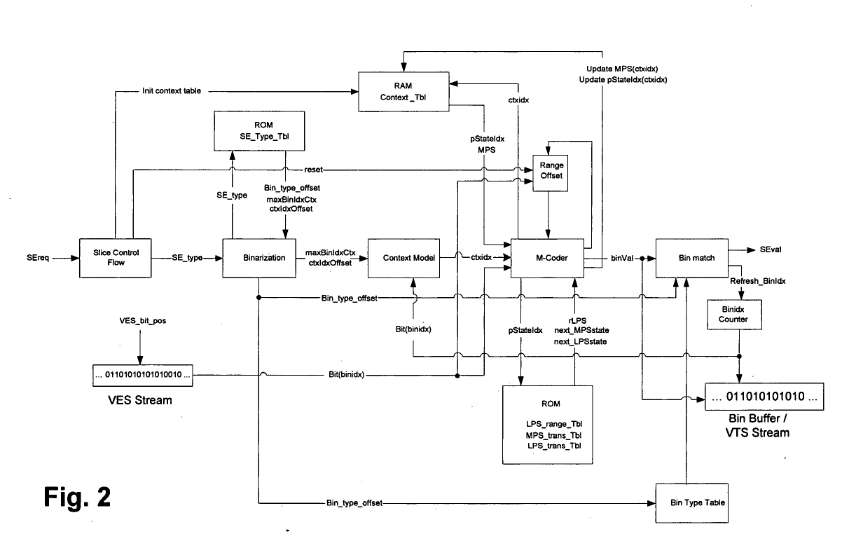

Each of the IPCM data determination block, bypass module, and mixer of the CABAC module can be implemented with conventional technology, as will be apparent in light of this disclosure. Likewise, the CIP_{—}1 and CIP_{—}2 modules can also be implemented with conventional technology. Alternatively, the CIP_{—}1 and CIP_{—}2 modules can be implemented as described in the previously incorporated U.S. application Ser. No. ______, filed June, xx 2005, titled “Extensible Architecture for Multi-Standard Variable Length Decoding”<attorney docket number 22682-10470>. The CABAC decoder pipeline will now be discussed in detail with reference to FIGS. 2-6.

CABAC Decoder Pipeline

FIG. 2 is a block diagram of a CABAC decoder pipeline configured for the two pass dataflow architecture, in accordance with one embodiment of the present invention.

As can be seen, the CABAC decoder pipeline for this configuration includes a slice control flow module, a binarization module, a context model, an M-coder module, and a bin match module. In addition to these five main modules, the pipeline further includes a number of supporting memories (e.g., RAM and ROM) and other functionality (e.g., counter and range offset modules) that will be described in turn.

The input (SEreq) of the slice control flow module is the request for the next syntax element in the parsing process of a H.264 CABAC bit stream, and its output (SE_type) is the selection of binarization type of the syntax element. In one particular embodiment, the slice control flow module is implemented with conventional technology, and implements the finite state machine (FSM) of the slice level parsing process of the H.264 bit stream. It starts with a current state of the FSM, and processes requests for the next syntax element type. The slice control flow module also initializes the context table when it begins to parse a new slice, in preparation for the context modeling of that slice. The slice control flow module of this embodiment is also configured to issue a reset signal for the range and offset values (e.g., stored in range and offset registers) for the CABAC decoder process.

The input to the binarization module is the type of the syntax element (SE_type) from the output of the slice control flow module. The binarization module has three outputs. They include the context index offset (ctxIdxOffset), the maximal number of bin index that the syntax element context covers (maxBinIdxCtx), and the bin type offset (Bin_type_offset). The ctxIdxOffset and maxBinIdxCtx are passed to the context model module for context modeling, while the Bin_type_offset is passed to the Bin Match module in the symbol matching decision to produce the syntax element values.

In operation, the binarization module branches the syntax element type into a number of different binarization types (e.g., six to eight types) based on a syntax element type table (SE_Type_Tbl), which in this case is implemented using a ROM lookup table (LUT). The SE_type is used to carry out the look up in the table SE_Type_Tbl, and the bin type offset (Bin_type_offset), the maximum bin index (maxBinIdxCtx), and the context index offset (ctxIdxOffset) are returned back as the result of the ROM LUT operation.

The binarization module also partitions the corresponding VES bits into prefix and suffix parts based on the Bin_type offset from the SE_Type_Tbl, with a different binarization rule applied to each part. The context index offset (ctxIdxOffset) value and the max value for the ctxIdxOffset is generated for each prefix or suffix part of the syntax element. These values are used in the next stage of the pipeline by the context model, as will be explained in turn.

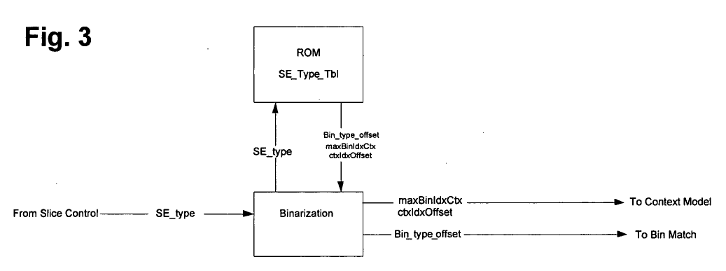

FIG. 3 is a block diagram of the binarizer of FIG. 2, configured in accordance with one embodiment of the present invention. In this particular case, the binarizer module includes the syntax element type table (SE_Type_Tbl). As previously discussed, the syntax element type (SE_type) is used to retrieve the bin type offset (Bin_type_offset), the maximum bin index (maxBinIdxCtx), and the context index offset (ctxIdxOffset). The bin type offset (Bin_type_offset) of this embodiment is provided to the bin match module. The context index offset (ctxIdxOffset) and the maximum bin index (maxBinIdxCtx) of this embodiment are then provided to the context model module.

Referring back to FIG. 2, the context model receives two inputs from the binarization module: the context index offset (ctxIdxOffset) value and the maximal number of bin index that this syntax element context covers (MaxBinIdxCtx). The context model also receives the bit count of the VTS bin within the syntax element from the bin index counter (Binidx Counter), which monitors the VTS output stream to establish the count. The output of the context model includes the context index (ctxidx) of the current bit of the current syntax element, which is provided to the M-coder, as shown.

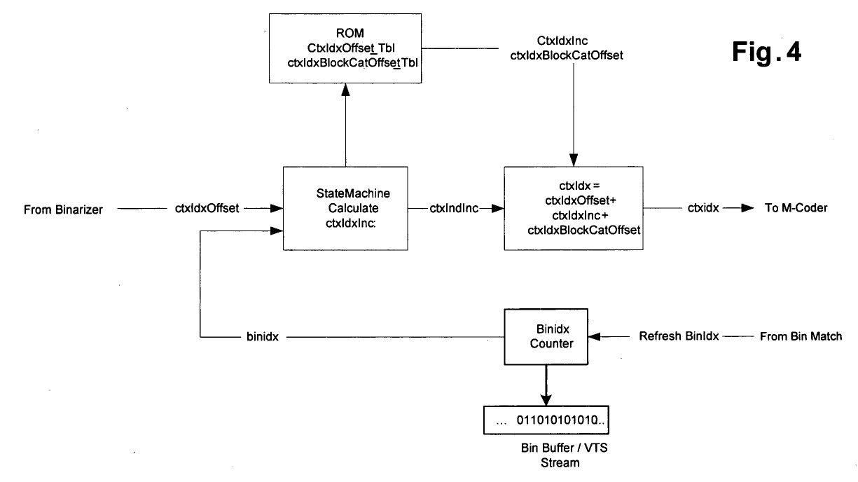

FIG. 4 is a block diagram of the context model of FIG. 2, configured in accordance with one embodiment of the present invention. As can be seen, the context model of this example includes the bin index counter (Binidx Counter), a state machine for calculating the increment value of the context index (ctxIdxInc), a ROM for storing a context index offset table (CtxIdxOffset_Tbl) and a context index block category offset table (ctxIdxBlockCatOffset_Tbl), and a context index (ctxIdx) calculator to form the ctxIdx as summation of ctxIdxOffset, ctxIdxInc and ctxIdxBlockCatOffset. In one such particular embodiment, the context model follows the context prediction rule of the H.264 standard to calculate the increment value of the context index (ctxIdxInc) and the context index block category offset (ctxIdxBlockCatOffset) value based on the previous occurred bin and syntax values, and to add them to the context index offset (ctxIdxOffset) value to get the final context index (ctxIdx) value. The final context index (ctxIdx) value is then passed to next stage for the M-coder decoding process. Note that the bin counter can be used in conjunction with a fixed length bit buffer to track the current decoded bin stream. As will be explained, a successful codeword matching by the bin match module generates a reset (Refresh_Binidx) of the bin counter. This prepares the bin counter for subsequent use.

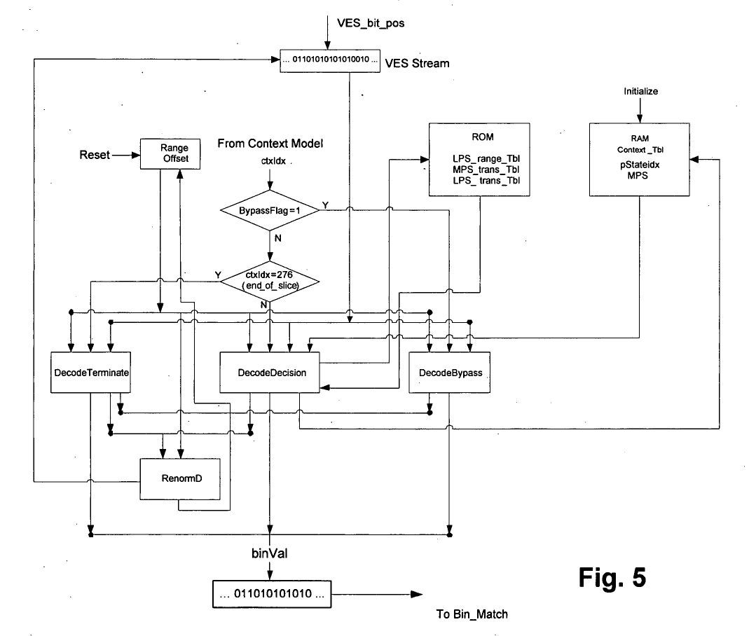

Referring back to FIG. 2, the M-coder module receives the context index (ctxIdx) value from the context model, as well as a pointer, Bit(binidx), pointing to the current bit parsing position of the VES stream. The M-coder output is the bin value (binVal) in the VTS. FIG. 5 is a block diagram of the M-coder of FIG. 2, configured in accordance with one embodiment of the present invention. As can be seen, this example embodiment includes range and offset registers (Range Offset), a decode terminate sub-module (DecodeTerminate), a renormalize data sub-module (RenormD), a decode decision ((DecodeDecision) sub-module, a decode bypass module (DecodeBypass), and logical determination blocks for detecting if the bypass flag is set (BypassFlag=1) and if the context is from the end of a slice syntax element (ctxIdx=276, end_of_slice). This example M-coder also includes a RAM for storing the context table (Context_Tbl), and a ROM for storing an LPS range table (LPS range_Tbl), an MPS transition table (MPS_trans_Tbl), and an LPS transition table (LPS_trans_Tbl). Note that MPS is most probable symbol, and LPS is least probable symbol.

In this configuration, the M-coder module uses two registers (Range and Offset) to keep track the current interval state of the M-coder. The interval is defined as [offset, offset+range]. The M-coder uses the context index (ctxIdx) value to access the context table (which in one specific embodiment is a RAM table that is 51 2×7 bits). In particular, the current probability state is accessed based on the context index value (ctxIdx). The probability state is specified by a 6 bit pStateIdx value and a 1 bit MPS value. These values are stored in the context table.

The probability state (pStateIdx) is used by the M-coder as an entry to retrieve information of the next range and probability. In particular, pStateIdx is used is used to retrieve LPS (least probable symbol) range (rLPS) from the LPS range table (LPS_range_Tbl), and to retrieve the next MPS (nextMPSstate) from the MPS transition table (MPS_trans_Tbl), and to retrieve the next LPS (nextLPSstate) from the LPS transition table (LPS_trans_Tbl). Then, based on the state of the MPS, and this next range and probability information, the M-coder calculates the MPS value of the current bin, which is the bin value (binVal) in the output VTS. The M-coder also updates the offset and range values to reflect the current interval range. The M-coder of this embodiment also updates the probability state for the next bin based on the selection of the MPS. The M-coder also writes the current MPS and probability state back to the context table for use of these parameters in future contexts.

The DecodeDecision module of the M-coder is the main path for the arithmetic bit decoding process. In the embodiment shown in FIG. 5, one input of the DecodeDecision is the context index value (ctxIdx), which comes from the context model module. Another input of the DecodeDecision is the bit pointer in the original VES stream (VES_bit_pos). Two other inputs are the range and offset values of the current M-coder decoding state. One output of the DecodeDecision is the bin value (binVal), which forms the final VTS stream as the CABAC output stream. Two other outputs are the range and offset values, which are passed to the RenormD module for an update of the range and offset values before they are saved back in the local registers which are kept for tracking the state of the current M-coder. Two other outputs are the pStateIdx and MPS values, which are written back to the context table (Context_Tbl) to keep track of the probability state of the context at the entry of ctxidx.

In one embodiment, the decoding process of the DecodeDecision module can be described as follows: First, the ctxIdx is used to access the local RAM context table (Context_Tbl) to get the current probability state pStateIdx and MPS values. Second, the pStateIdx and the current range value are used to read a LPS range value (rLPS) from the LPS_range_Tbl. Then, the rLPS value and the current offset value are used to decide the next bin symbol via the following routine:

if (offset< range − rLPS)

bin = MPS;

else

bin = LPS = 1−MPS;

The range value, offset values and the pStateIdx are then updated according to if the bin choice is the MPS or LPS as follows:

if (bin==MPS)

range = rLPS; offset = offset;
pStateIdx = MPS_trans_Tbl[pStateIdx];

else (bin=LPS)

range = range − rLPS; offset = offset − (range − rLPS);
pStateIdx = LPS_trans_Tbl[pStateIdx];

The MPS bit value is inverted if the pStateIdx value before the last update is 0. The MPS and pStateIdx are then written back to the context RAM Context_Tbl at the entry of ctxIdx for future use in the bits decoding process with the same context index (ctxIdx). The range and offset values are passed to the RenormD module for an update of the range and offset values before they are saved back in the local registers that are kept for tracking the state of the current M-coder.

The DecodeBypass module is a less complex path of the M-coder module. Its inputs include the bit pointer of VES (VES_bit_pos), the range value and offset value. It does not use the ctxIdx from the context modeling stage, and it does not update the pStateIdx and MPS values in the Context_Tbl. The bin value and offset update rule for this example embodiment is:

Offset = offset <<1 + new_bit;
If (offset>range)

Offset = offset − range;
Bin = 1;

Else

Bin = 0;

The range value is kept the same as before. Outputs of the DecodeBypass module include bin value, range and offset values. The bin value (binVal) forms the final VTS stream as the CABAC output stream. The range and offset values are saved in the local registers, which are kept for tracking the state of the current M-coder. There is no need to renormalize the offset and range value in the DecodeBypass.

The DecodeTerminate module of this embodiment has inputs including the bit position pointer of the VES stream, and the range and offset values. The update rule is:

Range = range − 2;
If (offset>range)

bin=1;

else

bin = 0; need renormalize later;

Outputs of the DecodeTerminate module of this embodiment, including the bin value (binVal) that forms the final VTS stream as the CABAC output stream. The range and offset values are passed to the RenormD module for an update of the range and offset values before they are saved back in the local registers, which are kept for tracking the state of the current M-coder.

The RenornD module inputs include the offset and range values, which are the state registers used by the M-coder to keep track of the current state of the decoding. Another input is the VES bit pointer (VES_bit_pos), which is used to keep track of the current bit position when the VES is parsed. The outputs of the RenormD module are the updated values of the offset and range as well as a new VES bit position. The RenormD module keeps appending the new bits from the bit position of the VES stream to the offset value, and left shifts the range value by the amount of new bits included from the YES, until the range value is no less than 256 bits. The VES bit position is updated to a new location where the next CABAC bit parsing occurs.

Referring back to FIG. 2, the bin match module receives the bin value (binVal) from the M-coder, and the binarization type corresponding to the particular syntax element. The binarization type in this embodiment is provided from a binarization type table (Bin Type Table). The output is the bin stream, which can also be referred to as the VTS, or syntax element values (SEval). The bin match module applies different binarization matching rules according to different binarization types with the bin stream coming out from the M-coder.

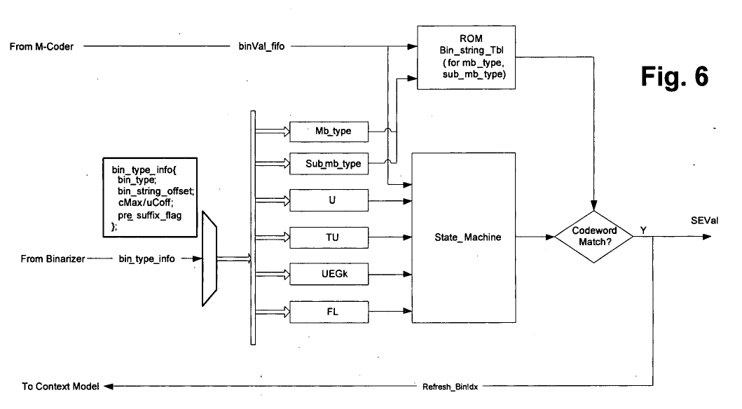

FIG. 6 is a block diagram of the bin match module of FIG. 2, configured in accordance with one embodiment of the present invention. The bin match module receives bin type offset (Bin_type_offset) from the binarizer and bin type from the Bin Type Table. From this information, macroblock type (mb_type) and sub block type (sub_mb_type) can be determined, for example, via a logical lookup table (LUT), which in this case is a ROM table (Bin_string_Tbl). Other types can be handled, for instance, by an FSM (State_Machine) corresponding to the unary (U), truncated unary (TU), concatenated unary/k-th order exp-Golomb (UEGk), and fixed length (FL) coding rules, as shown.

In one particular embodiment, the bin counter (Binidx Counter) of the context model is used in conjunction with a fixed length bit buffer (Bin_Buffer) each time there is an input from the M-coder. All the bits in the Bin_Buffer form a pattern, which is used in one of the symbol matching processes from the LUT, U, TU, UEGk or FL categories. A successful codeword matching generates output of a syntax element value and reset (Refresh_Binidx) of the bin counter of the context model. An unsuccessful codeword matching will, for example, increase the bin stream pattern until it finds a successful matching.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A two pass context-adaptive binary arithmetic coding (CABAC) architecture dataflow device, comprising:
a first code index parser (CIP) module for parsing and decoding syntax elements from an input video elementary stream (VES), which includes information at one or more of stream sequence, picture, and slice header levels;
a CABAC module for un-wrapping dependency of arithmetic interval and context modeling between consecutive bits from the input VES, and transferring the input VES to a video transformed stream (VTS) format in which there is no bit level dependency;
an external memory for storing the resulting VTS; and
a second CIP module for parsing and decoding syntax elements from the VTS.

2. The device of claim 1 wherein the device is implemented as an application specific integrated circuit (ASIC) to decode H.264 CABAC streams with substantial fluctuations of bits representing each macroblock in high definition television (HDTV) applications.

3. The device of claim 1 wherein in a first pass, the first CIP module and the CABAC module receive and process the input VES to produce the VTS, which is written to the external memory, and in a second pass, the VTS is read back from the external memory, and syntax element parsing is performed by the second CIP module to produce syntax element values originally coded in the VES stream.

4. The device of claim 1 wherein the first CIP module outputs macroblock stream and slice stream data corresponding to the input VES, and passes each stream to the CABAC module, which comprises:
an IPCM data determination block for analyzing the macroblock stream data, and determining if IPCM data mode is enabled;
a CABAC decoder pipeline for decoding the macroblock stream data if IPCM mode is not enabled; and
a bypass module for allowing the macroblock stream data to bypass the CABAC decoder pipeline if the IPCM mode is enabled; and
a mixer for combining the slice stream data and the macroblock stream data at the macroblock level to form the VTS.

5. The device of claim 4 wherein a byte prevention pattern is added to the VTS to make the parsing process performed by the second CIP module consistent with the first CIP module.

6. The device of claim 4 wherein the CABAC decoder pipeline comprises:
a slice control flow module for carrying out a slice level parsing process to determine a syntax element type from a bit stream;
a binarization module for using a syntax element type to determine a context index offset;
a context model for calculating a context index based on the context index offset;
an M-coder module for determining a bin value within a syntax element in the VTS, based on the context index; and
a bin match module for generating a bin stream that forms the VTS, based on bin values from the M-coder.

7. The device of claim 1 wherein the external memory is a double data rate (DDR) RAM.

8. The device of claim 1 wherein the resulting VTS is expanded in size to eliminate dependency that existed between bits within the VES.

9. The device of claim 8 wherein the expanded VTS is fed back from the external memory to the second CIP module, thereby providing a much higher performance throughput for syntax element parsing.

10. A two pass context-adaptive binary arithmetic coding (CABAC) architecture dataflow device, comprising:
a first pass section of the device for receiving and processing an input video elementary stream (VES) to produce a video transformed stream (VTS);
a memory for storing the VTS; and
a second pass section of the device for reading the VTS stream back from the memory, and performing syntax element parsing to produce syntax element values coded in the VES stream.

11. The device of claim 10 wherein the device is implemented as an application specific integrated circuit (ASIC) to decode H.264 CABAC streams with substantial fluctuations of bits representing each macroblock in high definition television (HDTV) applications.

12. The device of claim 10 wherein the VTS is expanded in size to eliminate dependency that existed between bits within the VES.

13. The device of claim 12 wherein the expanded VTS is fed back from the external memory to the second pass section, thereby providing a higher performance throughput for syntax element parsing.

14. The device of claim 10 wherein the first pass section receives a bit count of a bin value within a syntax element from a bin index counter, which monitors the VTS to establish the count.

15. The device of claim 10 wherein a byte prevention pattern is added to the VTS to make the parsing process performed by the second pass section consistent with the first pass section.

16. A two pass context-adaptive binary arithmetic coding (CABAC) architecture dataflow device, comprising:
a slice control flow module for carrying out a slice level parsing process to determine a syntax element type from a bit stream;
a binarization module for using a syntax element type to determine a context index offset;
a context model for calculating a context index based on the context index offset;
an M-coder module for determining a bin value within a syntax element in a video transformed stream (VTS), based on the context index;
a bin match module for generating a bin stream that forms the VTS, based on bin values from the M-coder;
an external memory for storing the VTS; and
a code index parser (CIP) module for parsing and decoding syntax elements from the stored VTS.

17. The device of claim 16 wherein the device is implemented as an application specific integrated circuit (ASIC) to decode H.264 CABAC streams with substantial fluctuations of bits representing each macroblock in high definition television (HDTV) applications.

18. The device of claim 16 wherein the VTS is expanded in size to eliminate dependency that existed between bits within the bit stream.

19. The device of claim 18 wherein the expanded VTS is fed back from the external memory to the second CIP module, thereby providing a much higher performance throughput for syntax element parsing.

20. The device of claim 16 wherein the context model receives a bit count of the bin value within a syntax element from a bin index counter, which monitors the VTS to establish the count.
